(19) United States
(12) Patent Application Publication
(10) Pub. No.: US 2010/0273666 A1
(43) Pub. Date: Oct. 28, 2010

(54) METHODS OF ANALYZING WOUND SAMPLES

(76) Inventors: Stephanie F. Bernatchez, Woodbury, MN (US); Katri M. Huikko, Cottage Grove, MN (US)

Correspondence Address: 3M INNOVATIVE PROPERTIES COMPANY, PO BOX 33427, ST. PAUL, MN, 55133-3427, US

(21) Appl. No.: 12/747,687

(22) PCT Filed: Dec. 10, 2008
(86) PCT No.: PCT/US08/86204

§ 371 Date: Jun. 11, 2010

Related U.S. Application Data
(60) Provisional application No. 61/013,488, filed on Dec. 13, 2007.

(51) Int. Cl. C40B 30/02; C40B 50/02

(52) U.S. Cl. 506/8; 506/24

(57) ABSTRACT

A method of analyzing wound samples is provided. The analysis typically involves the use of mass spectrometry.

### BACKGROUND

Wound healing is a highly coordinated physiological process involving a sequence of several overlapping processes, including homeostasis, inflammation, angiogenesis, granulation tissue formation, extracellular matrix deposition, and tissue remodeling. Wound healing proceeds normally in healthy individuals, but in subjects with underlying conditions such as vascular insufficiency or diabetes, wound healing is typically delayed. The microbial load of the wound is also known to be an important factor in delayed healing.

Many studies have been published comparing the components of exudate from chronic wounds and healing wounds and have documented that chronic wounds contain less total proteins and less albumin, more cytokines such as interleukin-1 (IL-1), interleukin-6 (IL-6), and tumor necrosis factor alpha (TNF-α), more growth factors such as epidermal growth factor (EGF), transforming growth factor alpha and beta (TGF-α and TGF-β) and insulin-like growth factor-1 (IGF-1), and more proteases such as plasmin and urokinase-like plasminogen activator (uPA), collagenase, and matrix metalloproteinases 2 and 9 (MMP-2 and MMP-9).

Other studies have also been published to document the presence of microorganisms in wounds, including detailed reviews. It is generally recognized that some organisms are more detrimental than others, such as anaerobic bacteria, β-hemolytic streptococci, S. aureus, Enterobacteriaceae, and Pseudomonas species. More recently, molecular methods have been used to describe the microflora in chronic wounds.

Examples of previously published studies have used techniques such as Enzyme Linked Immuno Assays (ELISA) to measure cytokines, growth factors, and zymography methods to measure proteases. However, these methods require preselection of the analytes to be measured.

It would be desirable to analyze wounds (e.g., using a wound fluid) using other methodologies without having to choose in advance which ones to measure.

### SUMMARY

The present invention provides methods of analyzing wound samples, particularly wound fluids. Preferably, the methods include using mass spectrometry, and more preferably Matrix-Assisted Laser Desorption/Ionization Time-of-Flight (MALDI-TOF) mass spectrometry. These methods give information on protein and/or peptide components of a wound sample, including protein and/or peptide components of microorganisms. They can be used to identify new markers for diagnosis and treatment of wounds, particularly wounds having impaired healing, such as chronic wounds.

In one embodiment, the present invention provides a method of analyzing a fluid from a wound of a subject. Such method can be used to identify protein and/or peptide components of a wound fluid, and in particular, to identify biological markers of wound healing. The method includes: acquiring a fluid sample from a wound (preferably, a chronic wound) of a subject (preferably, a human); submitting the sample to specific enzymatic digestion (preferably, using trypsin) to generate peptides in a digested sample; acquiring a spectrum of the digested sample using mass spectrometry (preferably, using matrix-assisted laser desorption/ionization time-of-flight spectrometry); comparing at least a portion of the spectrum to one or more protein identification databases of the species of the subject; and comparing at least a portion of the same spectrum to one or more protein identification databases of one or more microorganisms (particularly, bacteria).

In certain embodiments of this method, acquiring a spectrum of the digested sample using mass spectrometry comprises acquiring an MS spectrum of the digested sample; comparing at least a portion of the spectrum to one or more protein identification databases of the species of the subject comprises comparing at least a portion of the MS spectrum to one or more peptide mass fingerprint databases of the species of the subject; and comparing at least a portion of the same spectrum to one or more protein identification databases of one or more microorganisms comprises comparing at least a portion of the same MS spectrum to one or more peptide mass fingerprint databases of one or more microorganisms.

In certain other embodiments of this method, acquiring a spectrum of the digested sample using mass spectrometry comprises acquiring one or more MS/MS spectra of the digested sample; comparing at least a portion of the spectrum to one or more protein identification databases of the species of the subject comprises comparing at least a portion of the one or more MS/MS spectra to one or more MS/MS ion search queries in one or more protein identification databases of the species of the subject; and comparing at least a portion of the same spectrum to one or more protein identification databases of one or more microorganisms comprises comparing at least a portion of the same one or more MS/MS spectra to one or more MS/MS ion search queries in one or more protein identification databases of one or more microorganisms.

Herein, such methods involving comparing at least a portion of the spectra to protein identification databases can further include identifying one or more peptides and/or proteins of the wound fluid sample. Identifying one or more peptides and/or proteins of the wound fluid sample can involve identifying proteins and/or peptides that are in the protein identification databases and/or identifying proteins and/or peptides that are not in the protein identification databases. Such analysis typically involves the use of standard techniques well known to one of skill in the art (e.g., MS/MS analysis).

Herein, such methods involving comparing at least a portion of the spectra to protein identification databases can further include identifying one or more biological markers of wound healing.

The methods of analysis can further include creating a proteomic profile of a wound fluid of the subject. Herein, a proteomic profile of a wound fluid includes the protein and/or peptide profile of the species of the subject and optionally the protein and/or peptide profile of one or more microorganisms (particularly, bacteria) that may be present in the wound fluid. Such profiles do not necessarily include all proteins and/or peptides, but typically only need to include a minimum number that is characterizing.

The methods of analysis of the present invention can further include comparing the proteomic profile of the wound fluid from a chronic wound with a normally healing wound to identify markers of chronic wounds.

The methods of analysis of the present invention can further include comparing the proteomic profile of the wound fluid from one type of chronic wound with other types of chronic wounds to identify specific markers for each type of chronic wound.

The methods of analysis can further include diagnosing an impairment in wound healing of the subject.

The methods of analysis can further include identifying a treatment protocol for healing the wound, and, in addition (optionally), monitoring the response to the treatment protocol.

The methods of analysis can further include creating a time sequence of the proteins and/or peptides to monitor changes in the profile over time and optionally correlating such changes to the wound healing process (or lack thereof). This can also help in monitoring the response to a treatment protocol.

In another embodiment, the present invention provides a method of creating a library of proteins and/or peptides of wound fluid. Such proteins and/or peptides could be biological markers of wound healing specific to wounds. The method includes: acquiring a plurality of wound fluid samples from a plurality subjects of the same species; collecting relevant clinical parameters of the subjects (including, for example, age of the subject, duration of the wound, underlying disease of the subject (e.g., diabetes, venus insufficiency), the wound healing rate, etc.); submitting the samples to specific enzymatic digestion to generate peptides in digested samples; acquiring a spectrum of each digested sample using matrix-assisted laser desorption/ionization time-of-flight mass spectrometry; comparing at least a portion of each spectrum to one or more protein identification databases of proteins of the species of the subject; optionally (but preferably), comparing at least a portion of the same spectrum to one or more protein identification databases of proteins of one or more microorganisms; identifying peptides and/or proteins in each wound sample to create a proteomic profile; and analyzing the peptides and/or proteins and the clinical parameters to correlate the proteomic profile to the clinical parameters to create the library.

In certain embodiments of this method, acquiring a spectrum of each digested sample using mass spectrometry comprises acquiring an MS spectrum of each digested sample; comparing at least a portion of each spectrum to one or more protein identification databases of the species of the subject comprises comparing at least a portion of each MS spectrum to one or more peptide mass fingerprint databases of the species of the subject; and optionally, comparing at least a portion of the same spectrum to one or more protein identification databases of one or more microorganisms comprises optionally, comparing at least a portion of the same MS spectrum to one or more peptide mass fingerprint databases of one or more microorganisms. Preferably, these embodiments include comparing at least a portion of the same MS spectrum to one or more peptide mass fingerprint databases of one or more microorganisms.

In certain other embodiments of this method, acquiring a spectrum of each digested sample using mass spectrometry comprises acquiring one or more MS/MS spectra of the digested sample; comparing at least a portion of each spectrum to one or more protein identification databases of the species of the subject comprises comparing at least a portion of the one or more MS/MS spectra to one or more MS/MS ion search queries in one or more protein identification databases of the species of the subject; and optionally, comparing at least a portion of the same spectrum to one or more protein identification databases of one or more microorganisms comprises optionally, comparing at least a portion of the same one or more MS/MS spectra to one or more MS/MS ion search queries in one or more protein identification databases of one or more microorganisms. Preferably, these embodiments include comparing at least a portion of the same one or more MS/MS spectra to one or more MS/MS ion search queries in one or more protein identification databases of one or more microorganisms. Such comparisons can leave one or more peptides and/or proteins of the wound sample unidentified because they are not in the protein identification databases. Accordingly, methods of the present invention can involve the use of standard techniques (e.g., MS/MS analysis) to carry out such “de novo” analysis.

The embodiments described above involve digesting and analyzing a wound fluid using mass spectrometry. As used herein, “a wound fluid” is obtained from a wound either directly or by extracting wound tissue. It can include wound exudate and/or wound tissue extract or homogenate. However, it would also be possible to acquire a tissue sample, directly subject it to enzymatic digestion using, for example, trypsin, and acquiring a spectrum of a liquid portion of the digested sample using mass spectrometry.

Thus, in one embodiment, a method is provided that includes: acquiring a wound sample (e.g., a tissue sample) from a wound (preferably, a chronic wound) of a subject (preferably, a human); submitting the wound sample to specific enzymatic digestion (preferably, using trypsin) to generate peptides in a digested sample; acquiring a spectrum of a liquid portion of the digested sample using mass spectrometry (preferably, using matrix-assisted laser desorption/ionization time-of-flight spectrometry); comparing at least a portion of the spectrum to one or more protein identification databases of the species of the subject; and comparing at least a portion of the same spectrum to one or more protein identification databases of one or more microorganisms (particularly, bacteria).

In another embodiment, a method is provided that includes: acquiring a plurality of wound samples (e.g., tissue samples) from a plurality subjects of the same species; collecting relevant clinical parameters of the subjects (including, for example, age of the subject, duration of the wound, underlying disease of the subject (e.g., diabetes, venus insufficiency), the wound healing rate, etc.); submitting the samples to specific enzymatic digestion to generate peptides in digested samples; acquiring a spectrum of a liquid portion of each digested sample using matrix-assisted laser desorption/ionization time-of-flight mass spectrometry; comparing at least a portion of each spectrum to one or more protein identification databases of proteins of the species of the subject; optionally (but preferably), comparing at least a portion of the same spectrum to one or more protein identification databases of proteins of one or more microorganisms; identifying peptides and/or proteins in each wound sample to create a proteomic profile; and analyzing the peptides and/or proteins and the clinical parameters to correlate the proteomic profile to the clinical parameters to create the library.

The following definitions are provided for specific terms that are used in the following written description.

The terms “comprises” and variations thereof do not have a limiting meaning where these terms appear in the description and claims.

As used herein, “a,” “an,” “the,” “at least one,” and “one or more” are used interchangeably. Thus, for example, a sample that comprises a microorganism can be interpreted to mean that the sample includes “one or more” microorganisms. The term “and/or” means either (proteins or peptide) or both (proteins and peptides).

As used herein, “a chronic wound” is one that does not heal in a normal time frame of healing compared to a subject of similar age and health condition. Typically, a wound is chronic if it has not healed in months or years and can be characterized by one or more of the following: necrotic tissue, purulent exudate, excessive exudate, or offensive odor.

As used herein, “a normal wound” or a “non-chronic wound” or a wound of a “normal subject” is a wound that heals in a normal time frame (e.g., days or weeks).

As used herein, “biological markers of wound healing” include proteins and/or peptides, the presence of which, absence of which, or differential expression levels of which can be characteristic of wound healing, whether it is impaired or normal. Such markers can be from the subject with the wound or from a microorganism (e.g., bacterium) contaminating the wound, or both.

As used herein, “a subject” includes a human subject or other mammalian non-human species (e.g., dog, horse, cat).

As used herein, “a protein identification database” is a database of mass spectrometry (MS or MS/MS) data, which is used to match against experimentally obtained spectra. Examples of protein identification databases include peptide mass fingerprinting databases and MS/MS ion search databases such as the MS Protein Sequence Database, National Center for Biotechnology Information Database, and Swiss Proteomics Database (Swiss-Prot).

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 is a MALDI-TOF mass spectrum showing peptide ions recorded for one sample of human chronic wound fluid.

FIG. 2 show proteins implicated in the interleukin-4 signaling pathway identified in ten chronic wound patients.

### DETAILED DESCRIPTION OF ILLUSTRATIVE EMBODIMENTS

The present invention provides methods of analyzing wounds, preferably using mass spectrometry, and more preferably Matrix-Assisted Laser Desorption/Ionization Time-of-Flight (MALDI-TOF) mass spectrometry. This method gives information on protein and/or peptide components from wounds (e.g., wound fluid taken directly from a wound), and optionally protein and/or peptide components from microorganisms present in the wound. It can be used to identify new markers for diagnosis and treatment of wounds, particularly chronic wounds.

Using MALDI-TOF, the components of the wound fluid are identified on the basis of the molecular weight of representative peptides by comparison with public protein identification databases. It is possible to query public protein databases for human proteins and also for proteins other than those of human origin, such as bacterial species known to interfere with wound healing. This is relevant for wound fluid samples, as plasma samples are not expected to contain bacteria, except for septic subjects. In addition, the present invention provides a combined approach to look simultaneously at human and microorganism (particularly, bacterial) proteins from the same samples (using the same spectra) to give a more complete picture of the condition of wounds, particularly chronic wounds.

A preferred embodiment of the present invention analyzes wound fluid (which can include wound exudate and/or wound tissue extract or homogenate) from subjects with chronic wounds using matrix-assisted laser desorption/ionization time-of-flight (MALDI-TOF) mass spectrometry. This technique makes it possible to look at the protein and/or peptide profile of the samples at once and to identify markers of impaired healing. The technique also provides information that can help identify a treatment protocol, and allows monitoring a wound over time to evaluate the efficacy of a treatment and determine whether to continue the same treatment or modify the therapy. In the case of wound fluid, the method also has the potential to look at human proteins and microorganism (particularly, bacterial) proteins by querying different protein identification databases.

In a particularly preferred embodiment, the invention provides a method of analyzing a wound fluid in high throughput parallel analyses using MALDI mass spectrometry, enabling protein identification, molecular profiling, selection of promising drug targets, sorting and prioritizing of protein expression data, and the identification of abnormal physiological processes associated with chronic wounds.

One way to discover if substances are markers of wound healing, particularly impaired healing, is by determining if they are “differentially expressed” in biological samples from subjects exhibiting a chronic wound as compared to samples from subjects not having a chronic wound (e.g., those subjects undergoing elective surgery). For example, in mass spectra of samples comparing a group of subjects with chronic wounds and normal subjects, the average intensity of the generated signals at the mass-to-charge ratio A is higher in the samples from subjects with chronic wounds than the samples from the normal subjects. The marker at the mass-to-charge ratio A is said to be “differentially expressed” in chronic wounds, because the concentration of this marker is, on average, greater in samples from subjects with chronic wounds than in samples from normal subjects. If the concentration of the marker is generally greater in samples from subjects with chronic wounds than in the normal samples, the marker can also be characterized as being “up-regulated” for a chronic wound. If the concentration of the marker is generally less in the samples from subjects with chronic wounds than in the samples from normal subjects, the marker could be characterized as being “down-regulated.”

Another way to discover if substances are markers of wound healing, particularly impaired healing, is by monitoring biological samples from the same wound of the same subject over time and optionally correlating this with information with the clinical status of the wound (progression, regression, or static state).

In addition, differential expression is likely to occur between subjects with different types of chronic wounds. The methods of this invention enable the identification of these different expression profiles.

When a large number of mass spectra of a large number of biological samples are analyzed, it is not readily apparent which signals represent markers that might differentiate between a chronic state and a non-chronic state. A typical mass spectrum of a biological sample has numerous potential marker signals (e.g., greater than 200) and a significant amount of noise. This can make the identification of potentially significant signals and the identification of average signal differentials difficult. Consequently, it is difficult to identify and quantify potential markers. Unless the potential markers exhibit strong up-regulation or strong down-regulation, the average signal differential between samples from chronic subjects and samples from normal subjects may not be easily discernable.

Once markers are identified, however, they can be used as diagnostic tools. For example, a specific protein found to be correlated with wound healing, particularly impaired wound healing, in a plurality of diabetic patients during the building of a library can become a marker to diagnose a high probability of wound healing, particularly impaired healing, in diabetic patients.

Alternatively, methods of the present invention can be used to assess the presence of known markers of wound healing, particularly impaired wound healing. For example, a dataset can be searched for specific proteins known to be relevant for wound healing as identified from the published scientific literature. Such proteins include proteases such as matrix metalloproteinases (MMP-1, MMP-2, MMP-8, MMP-9), plasmin, urokinase-type plasminogen activator (uPA); protease inhibitors such as TIMP-1, TIMP-2, TIMP-3, PAI-1, PAI-2; molecules involved in nitric oxide synthesis and metabolism such as endothelial nitric oxide synthase and inducible nitric oxide synthase (eNOS, iNOS); growth factors such as epidermal growth factor (EGF), transforming growth factors (TGF-α, TGF-β1, TGF-β2, TGF-β3), insulin-like growth factor (IGF-1), platelet-derived growth factor (PDGF), and vascular endothelial growth factor (VEGF-2); and Inflammatory cytokines such as interleukins (IL-1, IL-6) and tumor necrosis factors (TNF-β). An advantage of the analytical method described herein is that many types of proteins and/or peptides can be identified in a proteomics approach.

In embodiments of the invention, each mass spectrum in the analyzed mass spectra could comprise signal strength data as a function of time-of-flight, a value derived from time-of-flight (e.g., mass-to-charge ratio, molecular weight, etc.), mass-to-charge ratio, or a value derived from mass-to-charge ratio (e.g., molecular weight). As known by those of ordinary skill in the art, mass-to-charge ratio values obtained from a time-of-flight mass spectrometer are derived from time-of-flight values. Mass-to-charge ratios may be obtained in other ways. For example, instead of using a time-of-flight mass spectrometer to determine mass-to-charge ratios, mass spectrometers using quadrupole analyzers and ion-trap mass analyzers can be used to determine mass-to-charge ratios.

In preferred embodiments, each mass spectrum comprises signal strength data as a function of mass-to-charge ratio. In a typical spectral view-type mass spectrum, the signal strength data may be in the form of “peaks” on a graph of signal intensity as a function of mass-to-charge ratio. Each peak may have a base and an apex, where peak width narrows from the base to the apex. The mass-to-charge ratio generally associated with the peak corresponds to the apex of the peak. The intensity of the peak is also generally associated with the apex of the peak.

Generally, the mass-to-charge ratio relates to the molecular weight of a potential marker. For example, if a potential marker has a charge of +1, then the mass-to-charge ratio is approximately equal to the molecular weight of the potential marker represented by the signal. Thus, while some mass spectra plots may show signal intensity as a function of molecular weight, the molecular weight parameter is in fact derived from mass-to-charge ratios.

While many specific embodiments of the invention discussed herein refer to the use of mass-to-charge ratios, it is understood that time-of-flight values, or other values derived from time-of-flight values, may be used in place of mass-to-charge ratio values in any of the specifically discussed exemplary embodiments.

In embodiments of the invention, a gas phase ion spectrometer mass may be used to create mass spectra. A “gas phase ion spectrometer” refers to an apparatus that measures a parameter that can be translated into mass-to-charge ratios of ions formed when a sample is ionized into the gas phase. This includes, e.g., mass spectrometers, ion mobility spectrometers, or total ion current measuring devices.

The mass spectrometer may use a suitable ionization technique. The ionization techniques may include, for example, fast atom/ion bombardment, matrix-assisted laser desorption/ionization (MALDI), surface enhanced laser desorption/ionization (SELDI), or electrospray ionization.

In some embodiments, an ion mobility spectrometer can be used to detect and characterize a marker. The principle of ion mobility spectrometry is based on the different mobility of ions. Specifically, ions of a sample produced by ionization move at different rates due to their difference in, e.g., mass, charge, or shape, through a tube under the influence of an electric field. The ions (typically in the form of a current) are registered at a detector and the output of the detector can then be used to identify a marker or other substances in the sample. One advantage of ion mobility spectrometry is that it can be performed at atmospheric pressure.

In certain embodiments, a laser desorption/ionization time-of-flight mass spectrometer is used to create the mass spectra. Laser desorption/ionization spectrometry is especially suitable for analyzing high molecular weight substances such as proteins. For example, the practical mass range for a MALDI can be up to 300,000 Daltons or more. Moreover, laser desorption/ionization processes can be used to analyze complex mixtures and have high sensitivity. In addition, the likelihood of protein fragmentation is lower in a laser desorption/ionization process such as a MALDI than in many other mass spectrometry processes. Thus, laser desorption/ionization processes can be used to accurately characterize and quantify high molecular weight substances such as proteins.

In a typical process for creating a mass spectrum, a sample is introduced into an inlet system of the mass spectrometer. The sample is then ionized. After the ions are generated, they are collected by an ion optic assembly, and then a mass analyzer disperses and analyzes the passing ions. The ions exiting the mass analyzer are detected by a detector.

For MALDI analysis, a sample is typically mixed with a matrix that absorbs at the used laser wavelength. The matrix includes a suitable organic matrix compound (e.g., α-cyano-4-hydroxycinnamic acid, sinapinic acid (3,5-dimethoxy-4-hydroxycinnamic acid), or 2,5-dihydroxy benzoic acid) dissolved in water and/or an organic solvent with optional additives (e.g., trifluoroacetic acid). The matrix is typically used in a molar excess, such as at least a 1000× molar excess and typically no more than a 10,000× molar excess. Typically, the sample and matrix are co-crystallized on a MALDI target plate after evaporation of the solvent. The crystallized sample-matrix mixture on the target plate surface is typically then exposed to an intense short-waved laser pulse in the high-vacuum area inside the ion source of the mass spectrometer and the charged molecules are released into the gas-phase for mass analysis.

In a time-of-flight mass analyzer, after leaving the source, the ions accelerated by a short high-voltage field pass a field-free drift region. At the far end of the drift region in the high vacuum, the ions strike a sensitive detector surface at different times. Since the time-of-flight of the ions is a function of the mass-to-charge ratio of the ions, the elapsed time between acceleration of ions and impact on the detector can be used to identify the presence or absence of molecules of specific mass-to-charge ratio. The time of flight data may then be converted into mass-to-charge ratios to generate a spectrum showing the signal strength of the sample components (e.g., peptides and/or proteins) as a function of mass-to-charge ratio.

Methods of the present invention can include the generation of MS data or MS/MS data. MS data is obtained by acquiring a full mass range spectrum of a sample. MS/MS experiments are used to detect specific structures within an unknown molecule. MS/MS experiments involve selecting one ion (=parent ion) recorded in the MS mode and acquiring a fragment ion spectrum (=daughter ion spectrum) for the selected and isolated parent ion. Selected parent ions can be fragmented using a variety of techniques, e.g., by laser-induced fragmentation, in-source fragmentation, post-source decay, or collision-induced fragmentation.

Mass spectra data (MS or MS/MS data) generated by ionization and detection of sample components can be preprocessed using a digital computer after or before generating a mass spectra plot. Data analysis can include the steps of determining the signal strength (e.g., height or area of signals) of a detected sample component and removing “outliers” (data deviating from a predetermined statistical distribution). For example, the observed signals can be normalized. Normalization is a process whereby the height of each signal relative to some reference is calculated. For example, a reference can be background noise generated by instrument and chemicals (e.g., an energy absorbing molecule). Then, the signal strength detected for each sample component or other substances can be displayed in the form of relative intensities in the scale desired (e.g., 0-100). Alternatively, a standard may be admitted with the sample so that a signal from the standard can be used as a reference to calculate relative intensities of the signals observed for each sample component detected.

### Sample Preparation

In one aspect, the samples are fluid samples obtained directly from a wound. For example, fluid can be obtained simply by using a sample acquisition (i.e., collection) device such as a “tea bag” or a swab or other sample acquisition device or other fluid collection system which can be used for microliter quantities of biological fluid. The sampling can be performed, for example, by inserting a swab dry or pre-moistened with an appropriate solution into the wound and rotating the swab. Such direct methods are preferred as they are minimally disruptive to the wound bed.

A wide variety of swabs or other sample collection devices are commercially available, for example, from Puritan Medical Products Co. LLC, Guilford, Me., under the trade designation PURE-WRAPS, or from Copan Diagnostics, Inc. Corona, Calif., under the trade designation microRheologics nylon flocked swab. A sample collection means such as that disclosed, for example, in U.S. Pat. No. 5,879,635 (Nason) can also be used if desired. Swabs can be of a variety of materials including cotton, rayon, calcium alginate, Dacron, polyester, nylon, polyurethane, and the like.

Sample collection devices referred to as “tea bags” can be prepared using chromatography paper (e.g., BFC180 from Whatman) cut into squares (e.g., 1 cm×1 cm) and each such square enclosed between two layers of dressing material (e.g., as TEGAPORE non-adherent dressing material from 3M HealthCare). The dressing material can be heat sealed to seal each square of paper on all four sides, and the resultant tea bags autoclaved.

Prior to sample collection, regardless of the type of device, a wound is typically cleaned using saline solution and sterile gauze. Wound fluid sampling can be done by holding, for example, a pad prepared as described above or a swab, against a wound until the pad is saturated or until a suitable sample is obtained. This procedure can be repeated with additional pads or swabs to collect samples for different analytical methods. The pads or swabs can be weighed before and after sampling to calculate the quantity of wound fluid collected. Samples are typically kept on ice until they can be transferred to a −70° C. freezer. All samples can be assayed together at the end of the study.

The sample collection device (e.g., swab) can then be analyzed directly or extracted with an appropriate reagent. Such extraction (i.e., elution) reagents typically include water, organic solvents, or buffers. Examples of elution solvents include acetonitrile, methanol, trifluoroacetic acid (TFA), and water. An example of an extraction buffer typically includes a physiological buffer such as phosphate buffered saline or HEPES buffer (e.g., at a molarity of 3 to 10 mM).

Typically, the elution solvents are used with a tea bag and the buffers are used with a swab for higher yield of sample extraction. In a preferred embodiment the extraction solvent used with a tea bag is trifluoroacetic acid (TFA) in water at a concentration ranging from 0.05 volume percent (vol-%) to 0.2 vol-%.

Typical extraction times include 30 minutes to 18 hours. Recovery can be enhanced using a variety of techniques including centrifuging, vortexing, and other mechanical methods to dislodge sample from the collection device.

In another aspect, the samples are extracts of wound tissue. Tissue samples can be obtained from a wound by biopsy and fluids extracted by tissue homogenization followed by extraction with water, solvents, or buffers, for example.

The wound fluid may be subjected to treatment prior to further analysis. This includes concentration, precipitation, filtration, distillation, dialysis, dilution, inactivation of natural components, addition of reagents, chemical treatment, etc. That is, the test sample can be prepared using a wide variety of means well-known to those of skill in the art.

In a preferred embodiment, the fluid sample may be further treated by at least partially removing high abundance proteins from the sample. Such high abundance proteins mask the presence of the signals of proteins/peptides present in lower amounts. Typically, such high abundance proteins include albumin and IgGs present in mammalian wound fluids. At least partial removal of such high abundance proteins can be carried out using standard “depletion” techniques (although “depletion” does not necessarily mean complete removal of such proteins). For example, at least partial removal of albumin and IgGs can be done using commercially available depletion columns.

The fluid sample is preferably submitted to specific enzymatic digestion to generate peptides in a digested sample. Typically, this is accomplished by contacting the sample with trypsin, although other enzymes such as chromotrypsin or pepsin can be used. Typically, the trypsin is provided in a buffer, such as an ammonium bicarbonate buffer or other bicarbonate buffers, for example. Preferably, the buffer is at a concentration of 40 mM to 60 mM, and more preferably 50 mM. Preferably, the pH of the buffer is adjusted to pH 8.5. Preferably, the enzyme concentration is 0.1 microgram/microliter to 0.3 microgram/microliter, and more preferably 0.2 microgram/microliter. Typical digestion times include 4 to 24 hours (preferably, 18 hours). Such digestion provides specific protein cleavage (meaning at specific sites) for peptide fingerprinting using mass spectrometry. For example, trypsin dominantly cleaves peptide chains at the carboxyl side of amino acids arginine and lysine. The specific cleavage becomes useful in interpreting the peptide fingerprinting mass spectrometry data (public databases have this taken into account).

It will be understood by one of skill in the art that, although discussion herein focuses on the specific enzymatic digestion of a wound fluid sample, a tissue sample could be directly subjected to specific enzymatic digestion using, for example, trypsin, and acquiring a spectrum of a liquid portion of the digested sample using mass spectrometry. Although this alternative is within the scope of the present invention, the digestion of a fluid sample (whether it is a sample of a wound exudate or a wound tissue extract or homogenate) and subsequent analysis is preferred.

Methods of the present invention involve identification of proteins and/or peptides of the subject from the wound fluid of the subject. Additionally, if desired, methods of the present invention can involve identification of proteins and/or peptides of microorganisms, particularly bacteria, present in the wound fluid of the subject. Although depletion and digestion can result in partial loss of bacterial proteins, methods of the present invention lead to the identification in the wound fluid samples of peaks specific to bacteria, as confirmed by the analysis of cultured isolates from the same samples using the same methods.

### Methods of Use

The present invention provides a wound diagnostic method to identify specific deficiencies in wounds that demonstrate impaired healing, particularly chronic wounds, and guide treatment selection. It is recognized that the longer a wound has been present, the harder it is to heal. Current treatment is empirical and consists in a trial-and-error approach using the multitude of wound care products available on the market, from simple moisture management dressings to high technology antimicrobial dressings, skin substitutes, and growth factors. Chronic wounds can be treated for several months before the optimal treatment is identified. This is detrimental to the quality of life of patients and contributes to the high cost of caring for wounds. The molecular diagnostic approach of the present invention provides a more rapid selection of the appropriate treatment, which can reduce the time to healing, and reduce the overall cost of the therapy.

In one aspect, wound fluid samples analyzed according to the invention are used to assay the expression and/or form of a biological marker for wound healing, which can be a protein and/or peptide. As used herein, “a biological marker for wound healing” is a protein and/or peptide, the presence of which, absence of which, or differential expression levels (decrease or increase) of which can be characteristic of wound healing, particularly impaired healing which occurs with a chronic wound. Additionally, different types of chronic wounds may be differentiated by such biological markers.

In further aspects of the invention, impaired wound healing can be detected and/or monitored by examining the expression of the activity of a biological marker for wound healing. For example, in one aspect, the activity of a component already known to be correlated with impaired healing such as matrix metalloproteases can be monitored in situ in samples.

In one aspect, diagnostic analyses are performed by determining which proteins and/or peptides in a wound fluid sample are substantially always present in a chronic wound and substantially always absent in a non-chronic wound, or substantially always absent in a chronic wound and substantially always present in a non-chronic wound, or substantially always present in a certain form or amount in a chronic wound and substantially always present in a certain other form or amount in a non-chronic wound. By “substantially always” it is meant that there is a statistically significant correlation between the expression/form of the protein/peptide or set of proteins/peptides and the presence of an aberrant physiological process.

Additionally, different types of wounds (e.g., chronic wounds) may be differentiated by such biological markers. In one aspect, diagnostic analyses are performed by determining which proteins and/or peptides in a wound fluid sample are substantially always present in a particular type of chronic wound and substantially always absent in the other types of chronic wound, or substantially always absent in a particular type of chronic wound and substantially always present in the other types of chronic wound, or substantially always present in a certain form or amount in a particular type of chronic wound and substantially always present in a certain other form or amount in the other types of chronic wound. By “substantially always” it is meant that there is a statistically significant correlation between the expression/form of the protein/peptide or set of proteins/peptides and the presence of an aberrant physiological process.

In one embodiment, the present invention provides a method of analyzing a fluid from a wound of a subject. The method includes: acquiring a fluid sample from a wound (preferably, a chronic wound) of a subject (preferably, a human); submitting the sample to specific enzymatic digestion (preferably, using trypsin) to generate peptides in a digested sample; acquiring a spectrum of the digested sample using mass spectrometry (preferably, using matrix-assisted laser desorption/ionization time-of-flight spectrometry, wherein preferably the matrix used in the matrix-assisted laser desorption/ionization time-of-flight spectrometry comprises an organic matrix compound selected from α-cyano-4-hydroxycinnamic acid, 3,5-dimethoxy-4-hydroxycinnamic acid, and 2,5-dihydroxy benzoic acid, dissolved in water and/or an organic solvent with optional additives); comparing at least a portion of the spectrum to one or more protein identification databases of the species of the subject; and comparing at least a portion of the same spectrum to one or more protein identification databases of one or more microorganisms (particularly, bacteria). Such comparisons can be used to identify protein and/or peptide components of a wound fluid, and/or be used to identify biological markers of wound healing.

In certain embodiments of this method, acquiring a spectrum of the digested sample using mass spectrometry comprises acquiring an MS spectrum of the digested sample; comparing at least a portion of the spectrum to one or more protein identification databases of the species of the subject comprises comparing at least a portion of the MS spectrum to one or more peptide mass fingerprint databases of the species of the subject; and comparing at least a portion of the same spectrum to one or more protein identification databases of one or more microorganisms comprises comparing at least a portion of the same MS spectrum to one or more peptide mass fingerprint databases of one or more microorganisms.

In certain other embodiments of this method, acquiring a spectrum of the digested sample using mass spectrometry comprises acquiring one or more MS/MS spectra of the digested sample; comparing at least a portion of the spectrum to one or more protein identification databases of the species of the subject comprises comparing at least a portion of the one or more MS/MS spectra to one or more MS/MS ion search queries in one or more protein identification databases of the species of the subject; and comparing at least a portion of the same spectrum to one or more protein identification databases of one or more microorganisms comprises comparing at least a portion of the same one or more MS/MS spectra to one or more MS/MS ion search queries in one or more protein identification databases of one or more microorganisms.

The microorganisms can be bacteria, fungi, yeast, for example, and preferably, bacteria. Particularly relevant organisms are bacteria including members of the family Enterobacteriaceae, or the family Micrococcaceae or the genera Staphylococcus spp., Pseudomonas spp., Escherichia spp. Particularly virulent organisms include Staphylococcus aureus (including resistant strains such as Methicillin Resistant Staphylococcus aureus (MRSA)), S. epidermidis, Enterococcus faecalis, Pseudomonas aeruginosa, and Escherichia coli. Other organisms of interest include, for example, Coryn stratium, Dermabecter hominis, S. dysgalactiae equisimilis, and E. faecalis.

Herein, such methods involving comparing to protein identification databases can further include identifying one or more biological markers of wound healing.

Herein, such methods involving comparing to protein identification databases can further include identifying one or more peptides and/or proteins of the wound sample. Identifying one or more peptides and/or proteins of the wound sample can involve identifying proteins and/or peptides that are in the protein identification databases and/or identifying proteins and/or peptides that are not in the protein identification databases.

Thus, the methods of analysis can further include creating a proteomic profile of the wound fluid of the subject. Herein, a proteomic profile of a wound fluid includes the protein and/or peptide profile of the species of the subject and optionally the protein and/or peptide profile of a microorganism (particularly bacteria).

The methods of analysis of the present invention can further include comparing the proteomic profile of the wound fluid from a chronic wound with a normally healing wound to identify markers of chronic wounds. The methods of analysis of the present invention can further include comparing the proteomic profile of the wound fluid from one type of chronic wound with the other types of chronic wounds to identify specific markers for each type. The methods of analysis can further include diagnosing the impairment in wound healing of the subject. The methods of analysis can further include identifying a treatment protocol for healing the wound, and additionally, if desired, monitoring the response to the treatment protocol.

The methods of analysis can further include creating a time sequence of the proteins and/or peptides to monitor changes in the profile (i.e., analyzing a wound fluid over time for relative abundance of certain components) and optionally correlate such changes to the wound healing process or lack thereof (progression, regression, or static state). This can also help in monitoring the response to a treatment protocol. Such evaluation of time sequence data can involve analysis of spectra of digested samples of the same wound from the same subject over time. This can be done before or after comparing spectra to one or more databases. If done before any such comparison, the amount of data used in such comparisons could be reduced. Also, such time sequence analysis can be used to better understand the healing process, to identify which proteins and/or peptides are important in the healing process, to identify markers for wound healing, and/or to monitor the response to a treatment protocol.

In another embodiment, the present invention provides a method of creating a library of proteins and/or peptides of wound fluid. Such proteins and/or peptides could be biological markers of wound healing specific to wounds. The method includes: acquiring a plurality of wound fluid samples from a plurality subjects of the same species; collecting relevant clinical parameters of the subjects (including, for example, age of the subject, duration of the wound, underlying disease of the subject (e.g., diabetes, venus insufficiency), the wound healing rate, etc.); submitting the samples to specific enzymatic digestion to generate peptides in digested samples; acquiring a spectrum of each digested sample using matrix-assisted laser desorption/ionization time-of-flight mass spectrometry (preferably, wherein the matrix used in the matrix-assisted laser desorption/ionization time-of-flight spectrometry comprises an organic matrix compound selected from α-cyano-4-hydroxycinnamic acid, 3,5-dimethoxy-4-hydroxycinnamic acid, and 2,5-dihydroxy benzoic acid, dissolved in water and/or an organic solvent with optional additives); comparing at least a portion of each spectrum to one or more protein identification databases of proteins of the species of the subject; optionally (but preferably), comparing at least a portion of the same spectrum to one or more protein identification databases of proteins of one or more microorganisms; identifying peptides and/or proteins in each wound sample to create a proteomic profile; and analyzing the peptides and/or proteins and the clinical parameters to correlate the proteomic profile to the clinical parameters to create the library.

In certain embodiments of this method, acquiring a spectrum of each digested sample using mass spectrometry comprises acquiring an MS spectrum of each digested sample; comparing at least a portion of each spectrum to one or more protein identification databases of the species of the subject comprises comparing at least a portion of each MS spectrum to one or more peptide mass fingerprint databases of the species of the subject; and optionally, comparing at least a portion of the same spectrum to one or more protein identification databases of one or more microorganisms comprises optionally, comparing at least a portion of the same MS spectrum to one or more peptide mass fingerprint databases of one or more microorganisms. Preferably, these embodiments include comparing at least a portion of the same MS spectrum to one or more peptide mass fingerprint databases of one or more microorganisms.

In certain other embodiments of this method, acquiring a spectrum of each digested sample using mass spectrometry comprises acquiring one or more MS/MS spectra of the digested sample; comparing at least a portion of each spectrum to one or more protein identification databases of the species of the subject comprises comparing at least a portion of the one or more MS/MS spectra to one or more MS/MS ion search queries in one or more protein identification databases of the species of the subject; and optionally, comparing at least a portion of the same spectrum to one or more protein identification databases of one or more microorganisms comprises optionally, comparing at least a portion of the same one or more MS/MS spectra to one or more MS/MS ion search queries in one or more protein identification databases of one or more microorganisms. Preferably, these embodiments include comparing at least a portion of the same one or more MS/MS spectra to one or more MS/MS ion search queries in one or more protein identification databases of one or more microorganisms.

In any of the methods described herein, one or more peptides and/or proteins of the wound sample may be unidentified because they are not in the protein identification databases. Accordingly, methods of the present invention can involve the use of standard techniques (e.g., MS/MS analysis) to carry out identification of such unknown proteins and/or peptides (“de novo” analysis).

Preferred embodiments described herein involve digesting and analyzing a wound fluid using mass spectrometry. As used herein, “a wound fluid” is obtained from a wound either directly or by extracting wound tissue. It can include wound exudate and/or wound tissue extract or homogenate. However, it would also be possible to acquire a tissue sample, directly subject it to specific enzymatic digestion using, for example, trypsin, and acquiring a spectrum of a liquid portion of the digested sample using mass spectrometry. Thus, each embodiment described herein could be carried out on a “wound sample” (a wound fluid or wound tissue sample) by digesting such wound sample and acquiring a spectrum of a liquid portion of the digested sample.

For example, in one embodiment, a method is provided that includes: acquiring a wound sample (e.g., a tissue sample) from a wound (preferably, a chronic wound) of a subject (preferably, a human); submitting the wound sample to specific enzymatic digestion (preferably, using trypsin) to generate peptides in a digested sample; acquiring a spectrum of a liquid portion of the digested sample using mass spectrometry (preferably, using matrix-assisted laser desorption/ionization time-of-flight spectrometry); comparing at least a portion of the spectrum to one or more protein identification databases of the species of the subject; and comparing at least a portion of the same spectrum to one or more protein identification databases of one or more microorganisms (particularly, bacteria).

In another embodiment, a method is provided that includes: acquiring a plurality of wound samples (e.g., tissue samples) from a plurality subjects of the same species; collecting relevant clinical parameters of the subjects (including, for example, age of the subject, duration of the wound, underlying disease of the subject (e.g., diabetes, venus insufficiency), the wound healing rate, etc.); submitting the wound samples (e.g., tissue samples) to specific enzymatic digestion to generate peptides in digested samples; acquiring a spectrum of a liquid portion of each digested sample using matrix-assisted laser desorption/ionization time-of-flight mass spectrometry; comparing at least a portion of each spectrum to one or more protein identification databases of proteins of the species of the subject; optionally (but preferably), comparing at least a portion of the same spectrum to one or more protein identification databases of proteins of one or more microorganisms; identifying peptides and/or proteins in each wound sample to create a proteomic profile; and analyzing the peptides and/or proteins and the clinical parameters to correlate the proteomic profile to the clinical parameters to create the library.

### Exemplary Embodiments

1. A method of analyzing a fluid from a wound, the method comprising:

acquiring a fluid sample from a wound of a subject;

submitting the sample to specific enzymatic digestion to generate peptides in a digested sample;

acquiring a spectrum of the digested sample using mass spectrometry;

comparing at least a portion of the spectrum to one or more protein identification databases of the species of the subject; and

comparing at least a portion of the same spectrum to one or more protein identification databases of one or more microorganisms.

2. The method of embodiment 1 wherein:

acquiring a spectrum of the digested sample using mass spectrometry comprises acquiring an MS spectrum of the digested sample;

comparing at least a portion of the spectrum to one or more protein identification databases of the species of the subject comprises comparing at least a portion of the MS spectrum to one or more peptide mass fingerprint databases of the species of the subject; and

comparing at least a portion of the same spectrum to one or more protein identification databases of one or more microorganisms comprises comparing at least a portion of the same MS spectrum to one or more peptide mass fingerprint databases of one or more microorganisms.

3. The method of embodiment 1 wherein:

acquiring a spectrum of the digested sample using mass spectrometry comprises acquiring one or more MS/MS spectra of the digested sample;

comparing at least a portion of the spectrum to one or more protein identification databases of the species of the subject comprises comparing at least a portion of the one or more MS/MS spectra to one or more MS/MS ion search queries in one or more protein identification databases of the species of the subject; and

comparing at least a portion of the same spectrum to one or more protein identification databases of one or more microorganisms comprises comparing at least a portion of the same one or more MS/MS spectra to one or more MS/MS ion search queries in one or more protein identification databases of one or more microorganisms.

4. The method of any one of embodiments 1 through 3 further comprising identifying one or more peptides and/or proteins of the wound fluid sample.

5. The method of embodiment 4 wherein identifying one or more peptides and/or proteins of the wound fluid sample comprises identifying proteins and/or peptides that are not in the protein identification databases.

6. The method of any one of embodiments 1 through 5 further comprising identifying one or more biological markers of wound healing.

7. The method of any one of embodiments 1 through 6 wherein the one or more microorganisms comprises one or more bacteria.

8. The method of any one of embodiments 1 through 7 wherein the wound fluid is obtained directly from a wound.

9. The method of any one of embodiments 1 through 8 wherein the wound is a chronic wound.

10. The method of any one of embodiments 1 through 9 wherein the subject is a human.

11. The method of any one of embodiments 1 through 10 wherein acquiring a wound fluid sample comprises contacting a collection device to a wound to collect wound fluid and extracting the wound fluid from the collection device.

12. The method of embodiment 11 wherein extracting comprises extracting with water, acetonitrile, methanol, trifluoroacetic acid, phosphate buffered saline, or HEPES buffer.

13. The method of embodiment 11 or embodiment 12 wherein acquiring a wound fluid sample further comprises at least partially removing high abundance proteins from the sample.

14. The method of embodiment 13 wherein the high abundance proteins include albumin and IgGs.

15. The method of any one of embodiments 1 through 14 wherein submitting the wound fluid sample to specific enzymatic digestion comprises contacting the sample with trypsin.

16. The method of embodiment 14 wherein the trypsin is provided in an ammonium bicarbonate buffer.

17. The method of any one of embodiments 1 through 16 wherein acquiring a spectrum of the digested sample using mass spectrometry comprises acquiring a spectrum of the digested sample using matrix-assisted laser desorption/ionization time-of-flight mass spectrometry.

18. The method of embodiment 17 wherein the matrix used in the matrix-assisted laser desorption/ionization time-of-flight mass spectrometry comprises an organic matrix compound selected from α-cyano-4-hydroxycinnamic acid, 3,5-dimethoxy-4-hydroxycinnamic acid, and 2,5-dihydroxy benzoic acid, dissolved in water and/or an organic solvent with optional additives.

19. The method of any one of embodiments 1 through 18 further comprising creating a proteomic profile of the wound fluid sample of the subject.

20. The method of embodiment 19 further comprising comparing the proteomic profile of the wound fluid sample from a chronic wound with a normally healing wound to identify markers of chronic wounds.

21. The method of embodiment 19 further comprising comparing the proteomic profile of the wound fluid sample from one type of chronic wound with other types of chronic wounds to identify specific markers for each type.

22. The method of embodiment 19 further comprising monitoring the proteomic profile of a wound fluid sample from the same wound over time.

23. The method of any one of embodiments 1 through 22 further comprising diagnosing an impairment in wound healing.

24. The method of any one of embodiments 1 through 23 further comprising identifying a treatment protocol for healing the wound.

25. The method of embodiment 24 further comprising monitoring the response to the treatment protocol.

26. The method of any one of embodiments 1 through 25 further comprising identifying one or more bacterial peptides and/or proteins of the wound sample.

27. The method of embodiment 26 wherein the one or more peptides comprises one or more peptides selected from the group consisting of AEANTGVSC (SEQ ID No.1), KLGNAVLR (SEQ ID No.2), VGGKNHLAP (SEQ ID No.3), SSPGYEGPR (SEQ ID No.4), LTHFYFDA (SEQ ID No.5), TVALTWWTRLP (SEQ ID No.6), IRFVNSGTEAVMTTIR (SEQ ID No.7), NNQLTSTPFDEIFAESNRK (SEQ ID No.8), GYNTIISHHPLIFKGVTSLK (SEQ ID No.9), PLKPNLHLVNKALHLWCSR (SEQ ID No.10), KFCNGLNCSKGYGVNLWWGT (SEQ ID No.11), and GGPPDTPRVNMGGGKWWMLVPRTFGTT (SEQ ID No.12).

28. A method of creating a library of proteins and/or peptides of wound fluid, the method comprising:

acquiring a plurality of wound fluid samples from a plurality subjects of the same species;

collecting relevant clinical parameters of the subjects;

submitting the samples to specific enzymatic digestion to generate peptides in digested samples;

acquiring a spectrum of each digested sample using matrix-assisted laser desorption/ionization time-of-flight mass spectrometry;

comparing at least a portion of each spectrum to one or more protein identification databases of proteins of the species of the subject;

optionally, comparing at least a portion of the same spectrum to one or more protein identification databases of proteins of one or more microorganisms;

identifying peptides and/or proteins in each wound sample to create a proteomic profile; and

analyzing the peptides and/or proteins and the clinical parameters to correlate the proteomic profile to the clinical parameters to create the library.

29. The method of embodiment 28 wherein:

acquiring a spectrum of each digested sample using mass spectrometry comprises acquiring an MS spectrum of each digested sample;

comparing at least a portion of each spectrum to one or more protein identification databases of the species of the subject comprises comparing at least a portion of each MS spectrum to one or more peptide mass fingerprint databases of the species of the subject; and

optionally, comparing at least a portion of the same spectrum to one or more protein identification databases of one or more microorganisms comprises optionally, comparing at least a portion of the same MS spectrum to one or more peptide mass fingerprint databases of one or more microorganisms.

30. The method of embodiment 29 further comprising comparing at least a portion of the same MS spectrum to one or more peptide mass fingerprint databases of one or more microorganisms.

31. The method of embodiment 28 wherein:

acquiring a spectrum of each digested sample using mass spectrometry comprises acquiring one or more MS/MS spectra of the digested sample;

comparing at least a portion of each spectrum to one or more protein identification databases of the species of the subject comprises comparing at least a portion of the one or more MS/MS spectra to one or more MS/MS ion search queries in one or more protein identification databases of the species of the subject; and

optionally, comparing at least a portion of the same spectrum to one or more protein identification databases of one or more microorganisms comprises optionally, comparing at least a portion of the same one or more MS/MS spectra to one or more MS/MS ion search queries in one or more protein identification databases of one or more microorganisms.

32. The method of embodiment 31 further comprising comparing at least a portion of the same one or more MS/MS spectra to one or more MS/MS ion search queries in one or more protein identification databases of one or more microorganisms.

33. The method of any one of embodiments 28 through 32 wherein the one or more microorganisms comprises one or more bacteria.

34. The method of any one of embodiments 28 through 33 wherein the wound fluid is obtained directly from a wound.

35. The method of any one of embodiments 28 through 34 wherein the wound is a chronic wound.

36. The method of any one of embodiments 28 through 35 wherein the subject is a human.

37. The method of any one of embodiments 28 through 36 wherein acquiring a sample comprises contacting a collection device to a wound to collect wound fluid and extracting the wound fluid from the collection device.

38. The method of embodiment 37 wherein extracting comprises extracting with water, acetonitrile, methanol, trifluoroacetic acid, phosphate buffered saline, or HEPES buffer.

39. The method of embodiment 37 or embodiment 38 wherein acquiring a sample further comprises at least partially removing high abundance proteins from the sample.

40. The method of embodiment 39 wherein the high abundance proteins include albumin and IgGs.

41. The method of any one of embodiments 28 through 40 wherein submitting the sample to specific enzymatic digestion comprises contacting the sample with trypsin.

42. The method of embodiment 41 wherein the trypsin is provided in an ammonium bicarbonate buffer.

43. The method of any one of embodiments 28 through 42 wherein identifying peptides and/or proteins of the wound sample comprises identifying proteins and/or peptides that are not in the protein identification databases.

44. The method of any one of embodiments 28 through 43 further comprising identifying one or more biological markers of wound healing.

45. The method of any one of embodiments 28 through 44 wherein the biological markers of wound healing are specific for chronic wounds.

46. The method of any one of embodiments 28 through 45 wherein the matrix used in the matrix-assisted laser desorption/ionization time-of-flight spectrometry comprises an organic matrix compound selected from α-cyano-4-hydroxycinnamic acid, 3,5-dimethoxy-4-hydroxycinnamic acid, and 2,5-dihydroxy benzoic acid, dissolved in water and/or an organic solvent with optional additives.

47. A method of analyzing a wound sample, the method comprising:

acquiring a sample from a wound of a subject;

submitting the wound sample to specific enzymatic digestion to generate peptides in a digested sample;

acquiring a spectrum of a liquid portion of the digested sample using mass spectrometry;

comparing at least a portion of the spectrum to one or more protein identification databases of the species of the subject; and

comparing at least a portion of the same spectrum to one or more protein identification databases of one or more microorganisms.

48. A method of creating a library of proteins and/or peptides of a wound sample, the method comprising:

acquiring a plurality of wound samples from a plurality subjects of the same species;

collecting relevant clinical parameters of the subjects;

submitting the wound samples to specific enzymatic digestion to generate peptides in digested samples;

acquiring a spectrum of a liquid portion of each digested sample using matrix-assisted laser desorption/ionization time-of-flight mass spectrometry;

comparing at least a portion of each spectrum to one or more protein identification databases of proteins of the species of the subject;

optionally, comparing at least a portion of the same spectrum to one or more protein identification databases of proteins of one or more microorganisms;

identifying peptides and/or proteins in each wound sample to create a proteomic profile; and

analyzing the peptides and/or proteins and the clinical parameters to correlate the proteomic profile to the clinical parameters to create the library.

### EXAMPLES

These examples are merely for illustrative purposes only and are not meant to be limiting on the scope of the appended claims. All parts, percentages, ratios, etc. in the examples and the rest of the specification are by weight, unless noted otherwise. Furthermore, molecular weights in the examples and the rest of the specification are weight average molecular weights, unless noted otherwise.

The following examples describe a shotgun proteomics method to analyze the protein composition of wound fluid from chronic wound patients using Matrix-Assisted Laser Desorption/Ionization Time-of-Flight (MALDI-TOF) mass spectrometry. Wound fluid samples were obtained from 13 patients with various chronic wounds using the Levine swab technique and analyzed using MALDI. In parallel, additional swabs were collected for microbiological analysis. The organisms were identified, counted and frozen for later use. Selected isolates from 12 patient subjects were re-grown in vitro for MALDI analysis. The MALDI spectra were analyzed using the Bruker Daltonics FlexAnalysis and Biotools software, and Mascot software.NCBInr and Swissprot MS and MS/MS databases were explored using ‘Homo sapiens’taxonomy for wound fluid samples and ‘Firmicutes’(gram positive bacteria) taxonomy for wound fluid samples and clinical isolates. Trypsin enzyme cleavage values were used for protein identification.

At the protein level, a large variability between wound fluids from different patient subjects was observed. The Ingenuity Pathways software was then used to combine the redundant proteins and to group the proteins in the relevant metabolic pathways. The IL-4 signaling pathway and the antigen presentation pathway were the most significantly represented in this group of patients.

For the selected group of clinical isolates, the mass spectra obtained were also compared to the wound fluid spectra from the same patients and some peaks previously unidentified when searching for human proteins were identified as peaks from bacterial proteins. For the selected peaks present in both wound fluids and in clinical isolates, MS/MS analysis was carried out for sequence confirmation.

This method can be useful to create a library of proteins expressed in wound fluid and therefore identify biological markers of wound healing. These markers are useful to evaluate the healing potential of patients with conditions that may impair healing, to diagnose impairment of wound healing, and to monitor the evolution of the condition as well as the response to treatments. In addition, bacterial proteins can potentially be identified in the same samples.

TABLE 1, below, shows selected patient subjects S1-S10, their underlying pathologies and some of the other clinical parameters relevant in subjects with impaired wound healing. From these subjects wound fluid samples were collected and subsequently analyzed according to methods of the present invention.

TABLE 1

| | Subject | | | | | | | | | |
|---|---|---|---|---|---|---|---|---|---|---|
| | S1 | S2 | S3 | S4 | S5 | S6 | S7 | S8 | S9 | S10 |
| Gender | M | F | F | M | M | M | M | F | M | F |
| Age | 69 | 67 | 70 | 48 | 48 | 59 | 55 | 41 | 55 | 60 |
| Wound type | NHS | VU | NHS | PU | PU | PU | PU | VU | VU | NHS |
| Underlying | Db | Db, | Db, | Db, | Db | P/Q | P/Q | PVD | PVD | Db, |
| pathologies | | CAD | PVD, | P/Q | | | | | | CAD |
| | | | CAD | | | | | | | |
| Smoking status | Yes | No | No | Yes | No | Yes | Yes | No | No | No |
| Wound | 999 | 60 | 104 | 712 | 120 | 715 | 120 | 120 | 60 | 60 |
| duration (days) | | | | | | | | | | |
| Antimicrobial | No | Yes | No | Yes | No | No | No | No | Yes | No |
| therapy | | | | | | | | | | |
| Enzymatic | No | Yes | No | No | No | No | Yes | No | No | No |
| debridement | | | | | | | | | | |
| Log aerobes | 2.58 | 2.58 | 4.95 | 4.54 | 2.54 | 3.71 | 4.34 | 5.78 | 4.67 | 3.73 |
| Log anaerobes | na | na | na | 5.51 | 2.30 | 3.36 | 6.57 | 6.30 | 4.65 | 2.60 |
| Wound | S | S | S | S | L | S | S | Un | S | S |
| progression | | | | | | | | | | |
| Wound pain | Dec | Dec | Un | None | Inc | Un | None | Un | Inc | Dec |
| Erythema | No | Yes | No | No | Yes | No | Yes | No | Yes | No |
| Edema | Yes | No | Yes | No | Yes | No | No | Yes | Yes | Yes |
| Temperature | No | No | No | No | No | No | Yes | Yes | No | No |
| increase | | | | | | | | | | |
| (periwound) | | | | | | | | | | |
| Purulent | No | No | Yes | No | No | No | No | No | No | No |
| exudate | | | | | | | | | | |
| Sanguinous | Yes | No | Yes | No | No | No | Yes | Yes | No | Yes |
| exudate | | | | | | | | | | |
| Serous exudate | Yes | Yes | Yes | No | Yes | Yes | Yes | Yes | No | Yes |
| Foul odor | No | No | No | Yes | No | No | Yes | No | No | No |

Abbreviations:
NHS: non-healing surgical wound;
VLU: venous leg ulcer;
PU: pressure ulcer;
Db: diabetes;
CAD: coronary artery disease;
PVD: peripheral vascular disease;
P/Q: paraplegia/quadriplegia;
S: smaller,
L: larger;
Un: unchanged;
Dec: decreasing;
Inc: increasing

### Wound Sample Collection Method

Samples were collected from the patient subjects described in Table 1 by using the quantitative swab technique described by Levine for the analysis of microbial load (Levine NS, Lindberg R B, Mason A D, Pruitt B A. The quantitative swab culture and smear: A quick, simple method for determining the number of viable aerobic bacteria on open wounds. J Trauma 16:89-94, 1976). In brief, the subject's wound was cleaned using a standard saline solution and sterile gauze. A single, sterile rayon swab (Copan Diagnostics Inc., Murrieta, Calif.) was rotated within a 1 cm² area of the wound for 5 seconds, applying sufficient pressure to express fluid from the underlying tissue. The swab was then placed in a tube containing HEPES buffer available from Sigma-Aldrich of St. Louis, Mo. Samples were kept on ice for no more than 3 hours and then transferred to a −70° C. freezer for storage prior to assay. All samples were assayed immediately after thawing.

### Clinical Isolates

Overnight cultures of the selected clinical isolates were grown on blood agar. The colonies (replicate samples of 1 colony from each studied patient subject) were then placed in tubes containing 100 μl of HEPES buffer (available from Sigma-Aldrich of St. Louis, Mo.). The micro-organism colony samples were then treated and analyzed similarly than the wound fluid samples. The samples were also analyzed without the albumin/IgG removal step as a comparison.

### Removal of High Abundance Proteins—Albumin/IgG Removal

The Albumin/IgG Removal Kit known as PROTEOEXTRACT (Cat# 122642 available from CALBIOCHEM EMD Chemicals, San Diego, Calif.) was used for the removal of high abundance proteins. The kit included ‘Albumin/IgG Removal Columns’ and ‘Binding Buffer.’ Following the kit instructions for use, the sample was prepared by first diluting 60 μl of wound fluid solution or 60 μl of micro-organism colony sample from clinical isolates with 540 μl of ‘Binding Buffer’ in a separate tube. The ‘Albumin/IgG Removal Column’ was prepared by removing the cap from the end and removing the storage buffer. Next the tip was removed from the column and the column was placed in an appropriate buffer collection tube. An amount of 0.85 μl of ‘Binding Buffer’ was added to the column and allowed to pass through the resin bed by gravity-flow. The buffer collection tube was discarded and the column was placed into a fresh sample collection tube. The Albumin/IgG was then removed from the sample by the following steps. The sample, previously diluted in the separate tube, was added to the column and allowed to pass through the resin bed by gravity-flow. The flow-through was collected. Using same collection tube, the column was washed with 600 μl of ‘Binding Buffer’, which was allowed to pass through the resin bed by gravity flow. This first wash fraction was collected. Using same collection tube another 600 μl of ‘Binding Buffer’ was allowed to pass through resin bed by gravity flow. The second wash fraction was collected. The combined fractions contained the Albumin/IgG-depleted sample. Sample aliquots of 50 μl each were then used for protein digestion.

Protein Digestion of Wound Fluid Samples and Micro-organism Colony Samples from Clinical Isolates

A buffer solution was prepared containing 50 mM ammonium bicarbonate (ABC) in water, pH 8.5 (ammonium bicarbonate available from Alfa Aesar, Ward Hill, Mass.). A Trypsin Stock Solution was prepared by dissolving 20 μg of trypsin (Sequence-Grade Modified Trypsin, available from Promega, Madison, Wis.) into 25 μl of ABC buffer solution and 75 μl of water. The Trypsin Stock Solution was kept on ice. An amount of 50 μl of sample solution, prepared above, was pipetted into a sterile polypropylene vial. The pH was adjusted with ammonium hydroxide to a pH of approximately 8.5. An amount of 5 μl of Trypsin Stock Solution was added to the sample solution. The sample was gently mixed by vortex for 5-10 seconds and digestion was carried out for 18 hours at 37° C. The reaction was stopped after 18 hours. The sample was allowed to cool to room temperature and then spun in a micro-centrifuge for 5-10 seconds at 6000 RPM (centrifuge model SD110 Clover Laboratories, Waterville, Ohio). The pH of the solution was adjusted to pH≦6 by adding acetic acid in 0.1 μl aliquots, as needed.

### MALDI-TOF Mass Spectrometry Analysis

MALDI-TOF mass spectrometry measurements were performed with an Ultraflex II Bruker MALDI-TOF/TOF instrument with positive ionization and in reflector mode. Acceleration voltage: 25 kV. The measured mass range: 680-8000 Daltons. The instrument was calibrated with peptide reference mixture ‘Peptide Calibration Standard’ available from Bruker Daltonics, Billerica, Mass. The MALDI matrix: α-cyano-4-hydroxycinnamic acid (CHCA; from Sigma Aldrich, St. Louis, Mo.) was prepared at the 10 mg/ml concentration level, which is a saturated matrix solution in an acetonitrile/water/trifluoro acetic acid (60/40/0.1%) mixture. Mixing of sample and matrix solution was carried out on MALDI target as follows. An amount of 1.0 μl of sample solution was applied on the MALDI target (a MTP Anchor Chip 800/384; Bruker Daltonics, Billerica, Mass.) and then 0.5 μl of MALDI matrix solution was applied on the MALDI target. The raw MALDI-TOF MS and MS/MS data was first processed using FlexAnalysis software, version 2.4 available from Bruker Daltonics. BioTools 3.0 software, also available from Bruker Daltonics, was then used for additional data processing and for transferring the data into the MASCOT PROTEIN IDENTIFICATION software version 2.1 available from Matrix Science Ltd, of London, UK. Using the MASCOT software, the National Center for Biotechnology Information (NCBI) NCBInr database and SwissProt peptide mass fingerprinting databases were explored using ‘Homo sapiens’ and ‘Firmicutes (gram positive bacteria)’ taxonomies and trypsin enzyme cleavage values. Search parameters were defined for protein ID as peptide tolerance of ±0.95 Da; max missed cleavage=1 and protein mass ‘unrestricted’. NCBinr and SwissProt sequence query and MS/MS ion searches were explored using the similar taxonomies and enzyme cleavage values than with the peptide mass fingerprinting (MS) databases. Peptide mass tolerance was <0.2 Da. Positive protein identification criteria were based on the probability based scores. Only the proteins with significant probability scores (p<0.05) indicating identity or extensive homology were considered as valid matches.

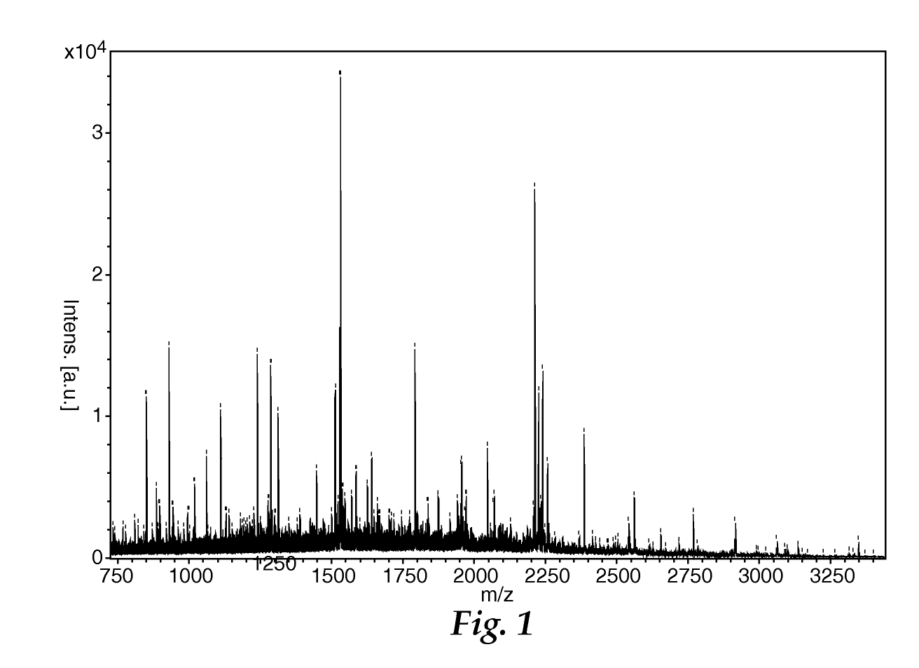

FIG. 1 shows MALDI-TOF mass spectrum showing peptide ions recorded for one wound fluid sample of one chronic wound subject (Subject #7). Table 2 shows the peak description (mass to charge ratio) for MALDI-TOF mass spectrum shown in FIG. 1. Results are shown for the top 50 peaks for Subject #7.

TABLE 2

| Peak # | m/z |
|---|---|
| 1 | 1530.0 |
| 2 | 2211.5 |
| 3 | 1529.0 |
| 4 | 1286.9 |
| 5 | 929.6 |
| 6 | 1239.7 |
| 7 | 1791.1 |
| 8 | 850.5 |
| 9 | 1512.1 |
| 10 | 1110.7 |
| 11 | 1311.9 |
| 12 | 2239.5 |
| 13 | 2225.5 |
| 14 | 1640.1 |
| 15 | 1285.8 |
| 16 | 2384.4 |
| 17 | 1060.7 |
| 18 | 2045.4 |
| 19 | 1956.3 |
| 20 | 1446.9 |
| 21 | 1018.6 |
| 22 | 2257.5 |
| 23 | 884.7 |
| 24 | 1659.1 |
| 25 | 1584.0 |
| 26 | 897.6 |
| 27 | 1624.0 |
| 28 | 1289.9 |
| 29 | 1280.9 |
| 30 | 1227.8 |
| 31 | 1536.0 |
| 32 | 1298.8 |
| 33 | 1139.7 |
| 34 | 1665.1 |
| 35 | 1667.1 |
| 36 | 1570.0 |
| 37 | 1708.1 |
| 38 | 1140.7 |
| 39 | 1275.8 |
| 40 | 1179.8 |
| 41 | 2560.5 |
| 42 | 1700.1 |
| 43 | 1717.1 |
| 44 | 1704.1 |
| 45 | 2070.4 |
| 46 | 1967.3 |
| 47 | 1586.1 |
| 48 | 1521.0 |
| 49 | 1350.9 |
| 50 | 1547.0 |
| — | — |
| — | — |

Table 3 shows the MALDI-TOF peak identification using Mascot peptide mass fingerprinting software (NCBInr database). Results shown are top 50 protein hits for Subject #7.

TABLE 3

| GI # | Protein ID |
|---|---|
| 33340525 | vascular endothelial growth factor 41 |
| 6330176 | KIAA1167 protein |
| 119571100 | GRIP1 associated protein 1, isoform CRA_a |
| 119571102 | GRIP1 associated protein 1, isoform CRA_c |
| 66348077 | GRIP1 associated protein 1 |
| 46592991 | GRIP1 associated protein 1, isoform 1 |
| 119571104 | GRIP1 associated protein 1, isoform CRA_e |
| 119571101 | GRIP1 associated protein 1, isoform CRA_b |
| 119571103 | GRIP1 associated protein 1, isoform CRA_d |
| 121278342 | interleukin 4 |
| 2905624 | interleukin 4 delta 2 |
| 10637030 | immunoglobulin heavy chain variable region |
| 19684189 | TBC1D25 protein |
| 1777479 | T cell receptor alpha chain |
| 443221 | Chain, Interleukin 4 |
| 349895 | Chain, Interleukin 4 (I1-4) Mutant with additional Met At N-Terminus |
| 27477092 | interleukin 4 isoform 2 precursor |
| 4504669 | interleukin 4 isoform 1 precursor |
| 42490871 | interleukin 4 isoform 1 precursor |
| 15826610 | Chain A, Interleukin-4 Mutant E9a |
| 109157435 | Chain A, Crystal structure of the interleukin-4 variant T13d |
| 109157203 | Chain A, Crystal structure of the interleukin-4 variant R85a |
| 109157204 | Chain A, Crystal structure of the interleukin-4 variant T13dr85a |
| 45709848 | Interleukin 4, isoform 1 precursor |
| 109157201 | Chain A, Crystal structure of the interleukin-4 variant F82d |
| 109157202 | Chain A, Crystal structure of the interleukin-4 variant T13df82d |
| 109157205 | Chain A, Crystal structure of the interleukin-4 variant F82dr85a |
| 146291105 | Zinc finger protein 562 |
| 6631029 | vascular endothelial growth factor isoform 121 precursor |
| 119571155 | ornithine aminotransferase-like 1, isoform CRA_b |
| 1800297 | death domain receptor 3 |
| 2071961 | lymphocyte associated receptor of death 6 |
| 2071959 | lymphocyte associated receptor of death 5 |
| 136490 | T-cell receptor alpha chain V region PY14 precursor |
| 338770 | T-cell receptor alpha-chain V-region (V-J-C) precursor |
| 553775 | T-cell receptor alpha |
| 88687 | T-cell receptor alpha chain precursor V region (HAVT18) (human, |
| | fragment) |
| 34364770 | hypothetical protein |
| 553662 | T-cell receptor alpha-chain V-region (V-J-C) precursor |
| 87299000 | immunoglobulin light chain variable region |
| 3980118 | Ig kappa light chain (VJ) |
| 481978 | Ig kappa chain |
| 4505087 | mago-nashi homolog |
| 83753648 | Chain A, Solution structure of Sh2 domain of human protein, Tyrosine |
| | Phosphatase Shp-1 |
| 338880 | T-cell receptor V-region (V-D-J) |
| 55959648 | poly(A) binding protein, cytoplasmic 4 (inducible form) |
| 119627521 | hCG23175 |
| 2570831 | death receptor 3 beta |
| 23200021 | tumor necrosis factor receptor superfamily, member 25 isoform 1 precursor |

A Comparison of wound fluid compositions in the group of 10 selected chronic wound patient subjects (Table 1) to identify common proteins was conducted. Data similar to the data presented in Table 3 was obtained for these 10 subjects. All detectable proteins were identified for each subject. In this series of 10 subjects, a total of 928 different proteins were identified. Of these, 22 proteins were present in at least 4 of the 10 subjects, and 144 proteins were present in 2-4 subjects. The list of the 22 proteins identified in at least 4 subjects is shown in Table 4.

TABLE 4

| Protein name | Description |
|---|---|
| HLA-C | major histocompatibility complex, class I, C |
| FGF2 | fibroblast growth factor 2 (basic) |
| HLA-B | major histocompatibility complex, class I, B |
| IL4 | interleukin 4 |
| HLA-DRB1 | major histocompatibility complex, class II, DR |
| | beta 1 |
| COL1A2 | collagen, type I, alpha 2 |
| TNXB | tenascin XB |
| ALB | Albumin |
| HLA-DRB5 | major histocompatibility complex, class II, DR |
| | beta 5 |
| RRAGC | Ras-related GTP binding C |
| ZNF226 | zinc finger protein 226 |
| RAB17 | RAB17, member RAS oncogene family |
| SULF2 | sulfatase 2 |
| B3GAT2 | beta-1,3-glucuronyltransferase 2 |
| | (glucuronosyltransferase S) |
| CEP290 | centrosomal protein 290 kDa |
| DKFZP564K142 | implantation-associated protein |
| LMO7 | LIM domain 7 |
| MYBPC1 (includes | myosin binding protein C, slow type |
| EG: 4604) | |
| NUP98 | nucleoporin 98 kDa |
| PABPC4 | poly(A) binding protein, cytoplasmic 4 |
| | (inducible form) |
| PHB2 | prohibitin 2 |
| RANBP3 (includes | RAN binding protein 3 |
| EG: 8498) | |

Table 5 below shows the 22 proteins found in at least 4 of the 10 chronic wound subjects with identified pathologies described in Table 1. Wound types for these subjects included the following. Subjects S1, S3 and S10 had non-healing surgical wounds. Subjects S2, S8 and S9 had venous ulcer wounds. Subjects S4, S5, S6 and S7 had pressure ulcer wounds.

TABLE 5

| Protein | S1 | S2 | S3 | S4 | S5 | S6 | S7 | S8 | S9 | S10 |
|---|---|---|---|---|---|---|---|---|---|---|
| ALB | — | X | — | X | X | X | — | — | X | — |
| B3GAT2 | X | — | — | X | — | — | X | X | — | — |
| CEP290 | — | X | — | — | — | X | X | X | — | — |
| COL1A2 | — | — | — | — | X | X | X | — | X | X |
| DKFZP564K142 | X | — | — | X | — | — | X | X | — | — |
| FGF2 | X | X | — | X | X | — | X | X | — | X |
| HLA-B | — | X | X | — | X | X | X | X | — | X |
| HLA-C | X | X | — | X | — | X | X | X | X | X |
| HLA-DRB1 | X | — | — | X | X | — | X | — | X | X |
| HLA-DRB5 | X | X | — | — | X | — | X | — | X | — |
| IL4 | X | X | — | — | — | X | X | — | X | X |
| LM07 | — | — | — | — | X | X | X | — | X | — |
| MYBPC1 | X | X | — | X | — | — | — | — | X | — |
| (includes EG: 4604) | | | | | | | | | | |
| NUP98 | X | — | — | X | X | — | — | — | X | — |
| PABPC4 | — | — | — | — | X | X | X | X | — | — |
| PHB2 | X | — | — | — | X | X | — | X | — | — |
| RAB17 | — | — | — | — | X | X | — | X | — | X |
| RANBP3 | — | X | — | — | X | — | X | — | X | — |
| (includes EG: 8498) | | | | | | | | | | |
| RRAGC | X | — | — | X | X | X | — | — | X | — |
| SULF2 | X | X | — | — | — | — | X | — | — | X |
| TNXB | X | X | — | — | — | — | X | — | X | X |
| ZNF226 | — | X | X | — | X | X | X | — | — | — |

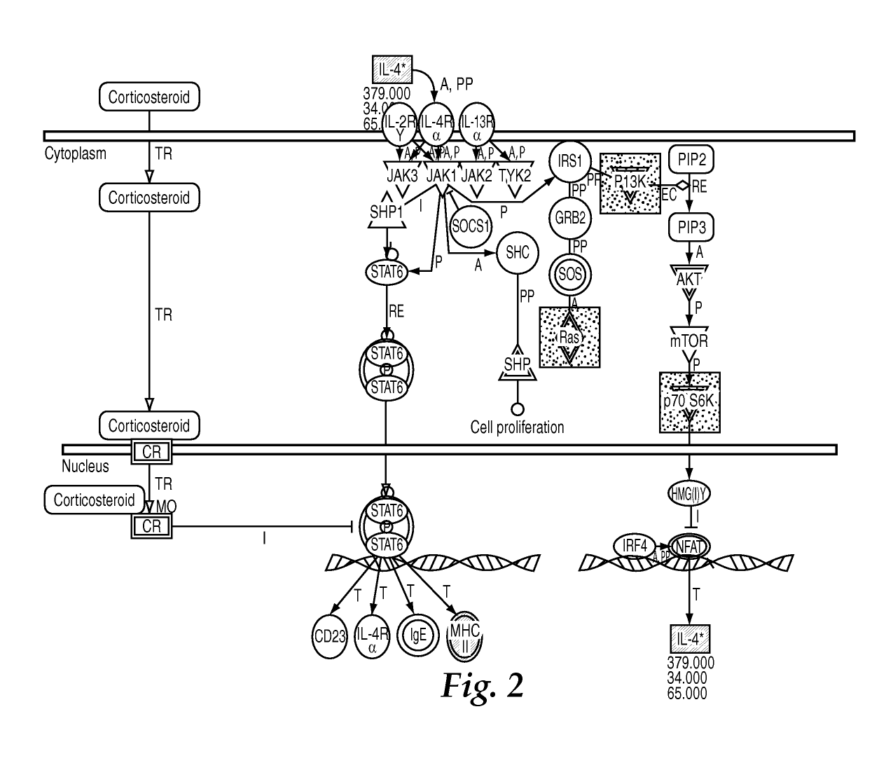

FIG. 2 shows biological pathways and networks identified in the group of 10 chronic wound subjects. In addition to identifying individual proteins, the proteins were identified by association with the interleukin-4 signaling pathway in which these proteins are involved. This was done between May-June 2007 by using commercially available software called Ingenuity Pathways available from Ingenuity Systems of Mountain View, Calif. (Ingenuity Systems, www.ingenuity.com). The proteins identified in a series of samples were uploaded in this software, which displayed the relationships of these proteins with well-known metabolic and signaling pathways. The composite view shown in FIG. 2 displays as highlighted all proteins from the IL-4 pathway found in any given subject of the group studied.

Table 6, below, provides the detailed list of proteins implicated in the interleukin-4 signaling pathway identified in the 10 chronic wound subjects and highlighting which protein was found in which subject. The proteins found in each subject are marked with an “X”.

TABLE 6

| Gene | | | | | | | | | | |
|---|---|---|---|---|---|---|---|---|---|---|
| Symbol | S1 | S2 | S3 | S4 | S5 | S6 | S7 | S8 | S9 | S10 |
| HLA-DRB1 | X | — | — | X | X | — | X | — | X | X |
| HLA-DRB5 | X | X | — | — | X | — | X | — | X | — |
| IL4 | X | X | — | — | — | X | X | — | X | X |
| RPS6KB2 | X | — | — | — | — | — | — | — | — | — |
| PIK3CB | — | — | — | — | X | — | — | — | — | — |
| HLA-DQB1 | — | — | — | — | — | — | X | X | — | — |
| HRAS | — | — | X | — | — | — | — | — | — | — |
| RRAS2 | — | — | — | — | — | — | — | X | — | — |

Table 7, below, shows other more recognizable names and descriptions for the gene symbol used in the interleukin-4 signaling pathway shown in FIG. 2 and in column 1 of Table 6.

TABLE 7

| Gene Symbol | Synonym | Description |
|---|---|---|
| HLA-DRB1 | DR-7, DR-9, DR1, DR1 BETA | Major histocompatibility |
| | CHAIN, DR8, DRB1, E-beta-b, H-2E | complex, class II, DR beta 1 |
| | beta, H-2Eb, H2-Eb1, HLA-DR1B, Ia- | |
| | 4, MGC105710, MHC Class I DR7, | |
| | MHC Class I IIDR2, Mhc class2 beta, | |
| | RT1-D beta, RT1-Db, RT1-Db1, RT1- | |
| | Db1n | |
| HLA-DRB5 | MAJOR HISTOCOMPATIBILITY | Major histocompatibility |
| | COMPLEX, CLASS2, DR BETA 5 | complex, class II, DR beta 5 |
| IL4 | BSF1, IgG1, Il4e12, INTERLEUKIN | Interleukin 4 |
| | 4, MGC79402 | |
| RPS6KB2 | 70 kDa, KLS, P54, p70 S6 kinase beta, | Ribosomal protein S6 kinase, |
| | p70 S6k beta, p70(S6K)-beta, P70- | 70 kDa, polypeptide 2 |
| | BETA, P70-beta-1, P70-beta-2, | |
| | p70S6KB, S6K-beta, S6K-beta2, | |
| | S6K2, SRK, STK14B | |
| PIK3CB | 1110001J02Rik, AI447572, DKFZp779 | Phosphoinositide-3-kinase, |
| | K1237, MGC133043, MGC150132, P11 | catalytic, beta polypeptide |
| | 0 BETA, Pi-3-Kinase, p110, Beta | |
| | Subunit, PI3K, PI3K BETA, PIK3C1 | |
| HLA-DQB1 | CELIAC1, HLA DR3, 3, HLA- | Major histocompatibility |
| | DQB, IDDM1 | complex, class II, DQ beta 1 |
| HRAS | — | v-Ha-ras Harvey rat sarcoma |
| | | viral oncogene homolog |
| RRAS2 | — | related ras(r-ras) |

TABLE 8
Bacterial species dominant in wound fluid samples

| Subject | Bacterial species |
|---|---|
| 1 | Staphylococcus aureus |
| 2 | Staphylococcus aureus |
| 3 | Staphylococcus aureus |
| 4 | Coryn stratium |
| 5 | Coryn stratium |
| 6 | Dermabacter hominis |
| 7 | S. dysgalactiae equisimilis |
| 8 | P. aeuriginosa, E. faecalis |
| 9 | E. coli |
| 10 | S. epidermidis |
| 11 | Staphylococcus aureus |
| 12 | Staphylococcus aureus |
| 13 | S. epidermidis |

```
TABLE 9
Examples of unique peptide peaks (approximate m/z; potential
markers) recorded for the clinical isolate (dominant
organism: S. aureus) and for the wound fluid from the same
  patient subjects. Top ranking sequences and protein
  identifications determined by MS and MS/MS (with p < 0.05;
identity or extensive homology).
```

| | | Protein | No. of | |
|---|---|---|---|---|
| | | Identification | matched | Mr |
| m/z | Sequence | (p < 0.05) | peaks | error |
| 851 | AEANTGVSC | | | |
| | (SEQ ID No. 1) | | | |
| 871 | KLGNAVLR | Ribonuclease | 30 | <0.05 |
| | (SEQ ID No. 2) | P protein | | Da |
| | | component | | |
| 893 | VGGKNHLAP | Not Available | | |
| | (SEQ ID No. 3) | (NA) | | |
| 950 | SSPGYEGPR | NA | | |
| | (SEQ ID No. 4) | | | |
| 1014 | LTHFYFDA | NA | | |
| | (SEQ ID No. 5) | | | |
| 1343 | TVALTWWTRLP | NA | | |
| | (SEQ ID No. 6) | | | |
| 1795 | IRFVNSGTEAVMTTIR | Glutamate-1- | 27 | <0.05 |
| | (SEQ ID No. 7) | semialdehyde | | Da |
| | | 2,1-amino- | | |
| | | mutase | | |
| 2211 | NNQLTSTPFDEIFAESNRK | 6-Phospho- | 40 | <0.05 |
| | (SEQ ID No. 8) | fructokinase | | Da |
| 2225 | GYNTIISHHPLIFKGVTSLK | UPF 0135 | 24 | <0.05 |
| | (SEQ ID No. 9) | protein | | Da |
| 2240 | PLKPNLHLVNKALHLWCSR | NA | | |
| | (SEQ ID No. 10) | | | |
| 2247 | KFCNGLNCSKGYGVNLWWGT | NA | | |
| | (SEQ ID No. 11) | | | |
| 2915 | GGPPDTPRVNMGGGKWWMLVPRTFGTT | NA | | |
| | (SEQ ID No. 12) | | | |

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments set forth herein and that such embodiments are presented by way of example only, with the scope of the invention intended to be limited only by the claims.

### SEQUENCE FREE TEXT

(SEQ ID Nos.1-12) Clinical Isolate Peptides

1. A method of analyzing a fluid from a wound, the method comprising:
acquiring a fluid sample from a wound of a subject;
submitting the sample to specific enzymatic digestion to generate peptides in a digested sample;
acquiring a spectrum of the digested sample using mass spectrometry;
comparing at least a portion of the spectrum to one or more protein identification databases of the species of the subject; and
comparing at least a portion of the same spectrum to one or more protein identification databases of one or more microorganisms.

2. The method of claim 1 wherein:
acquiring a spectrum of the digested sample using mass spectrometry comprises acquiring an MS spectrum of the digested sample;
comparing at least a portion of the spectrum to one or more protein identification databases of the species of the subject comprises comparing at least a portion of the MS spectrum to one or more peptide mass fingerprint databases of the species of the subject; and
comparing at least a portion of the same spectrum to one or more protein identification databases of one or more microorganisms comprises comparing at least a portion of the same MS spectrum to one or more peptide mass fingerprint databases of one or more microorganisms.

3. The method of claim 1 wherein:
acquiring a spectrum of the digested sample using mass spectrometry comprises acquiring one or more MS/MS spectra of the digested sample;
comparing at least a portion of the spectrum to one or more protein identification databases of the species of the subject comprises comparing at least a portion of the one or more MS/MS spectra to one or more MS/MS ion search queries in one or more protein identification databases of the species of the subject; and
comparing at least a portion of the same spectrum to one or more protein identification databases of one or more microorganisms comprises comparing at least a portion of the same one or more MS/MS spectra to one or more MS/MS ion search queries in one or more protein identification databases of one or more microorganisms.

4. The method of claim 1 further comprising identifying one or more peptides and/or proteins of the wound fluid sample.

5. A method of creating a library of proteins and/or peptides of wound fluid, the method comprising:
acquiring a plurality of wound fluid samples from a plurality subjects of the same species;
collecting relevant clinical parameters of the subjects;
submitting the samples to specific enzymatic digestion to generate peptides in digested samples;
acquiring a spectrum of each digested sample using matrix-assisted laser desorption/ionization time-of-flight mass spectrometry;
comparing at least a portion of each spectrum to one or more protein identification databases of proteins of the species of the subject;
optionally, comparing at least a portion of the same spectrum to one or more protein identification databases of proteins of one or more microorganisms;
identifying peptides and/or proteins in each wound sample to create a proteomic profile; and
analyzing the peptides and/or proteins and the clinical parameters to correlate the proteomic profile to the clinical parameters to create the library.

6. The method of claim 5 wherein:
acquiring a spectrum of each digested sample using mass spectrometry comprises acquiring an MS spectrum of each digested sample;
comparing at least a portion of each spectrum to one or more protein identification databases of the species of the subject comprises comparing at least a portion of each MS spectrum to one or more peptide mass fingerprint databases of the species of the subject; and
optionally, comparing at least a portion of the same spectrum to one or more protein identification databases of one or more microorganisms comprises optionally, comparing at least a portion of the same MS spectrum to one or more peptide mass fingerprint databases of one or more microorganisms.

7. The method of claim 6 further comprising comparing at least a portion of the same MS spectrum to one or more peptide mass fingerprint databases of one or more microorganisms.

8. The method of claim 5 wherein:
acquiring a spectrum of each digested sample using mass spectrometry comprises acquiring one or more MS/MS spectra of the digested sample;
comparing at least a portion of each spectrum to one or more protein identification databases of the species of the subject comprises comparing at least a portion of the one or more MS/MS spectra to one or more MS/MS ion search queries in one or more protein identification databases of the species of the subject; and
optionally, comparing at least a portion of the same spectrum to one or more protein identification databases of one or more microorganisms comprises optionally, comparing at least a portion of the same one or more MS/MS spectra to one or more MS/MS ion search queries in one or more protein identification databases of one or more microorganisms.

9. A method of analyzing a wound sample, the method comprising:
acquiring a sample from a wound of a subject;
submitting the wound sample to specific enzymatic digestion to generate peptides in a digested sample;
acquiring a spectrum of a liquid portion of the digested sample using mass spectrometry;
comparing at least a portion of the spectrum to one or more protein identification databases of the species of the subject; and
comparing at least a portion of the same spectrum to one or more protein identification databases of one or more microorganisms.

10. A method of creating a library of proteins and/or peptides of a wound sample, the method comprising:
acquiring a plurality of wound samples from a plurality subjects of the same species;
collecting relevant clinical parameters of the subjects;
submitting the wound samples to specific enzymatic digestion to generate peptides in digested samples;
acquiring a spectrum of a liquid portion of each digested sample using matrix-assisted laser desorption/ionization time-of-flight mass spectrometry;
comparing at least a portion of each spectrum to one or more protein identification databases of proteins of the species of the subject;
optionally, comparing at least a portion of the same spectrum to one or more protein identification databases of proteins of one or more microorganisms;
identifying peptides and/or proteins in each wound sample to create a proteomic profile; and
analyzing the peptides and/or proteins and the clinical parameters to correlate the proteomic profile to the clinical parameters to create the library.


SEQUENCE LISTING (12 sequences)

SEQ ID NO: 1 - protein, 9 aa, artificial
  clinical isolate peptide
AEANTGVSC

SEQ ID NO: 2 - protein, 8 aa, artificial
  clinical isolate peptide
KLGNAVLR

SEQ ID NO: 3 - protein, 9 aa, artificial
  clinical isolate peptide
VGGKNHLAP

SEQ ID NO: 4 - protein, 9 aa, artificial
  clinical isolate peptide
SSPGYEGPR

SEQ ID NO: 5 - protein, 8 aa, artificial
  clinical isolate peptide
LTHFYFDA

SEQ ID NO: 6 - protein, 11 aa, artificial
  clinical isolate peptide
TVALTWWTRLP

SEQ ID NO: 7 - protein, 16 aa, artificial
  clinical isolate peptide
IRFVNSGTEAVMTTIR

SEQ ID NO: 8 - protein, 19 aa, artificial
  clinical isolate peptide
NNQLTSTPFDEIFAESNRK

SEQ ID NO: 9 - protein, 20 aa, artificial
  clinical isolate peptide
GYNTIISHHPLIFKGVTSLK

SEQ ID NO: 10 - protein, 19 aa, artificial
  clinical isolate peptide
PLKPNLHLVNKALHLWCSR

SEQ ID NO: 11 - protein, 20 aa, artificial
  clinical isolate peptide
KFCNGLNCSKGYGVNLWWGT

SEQ ID NO: 12 - protein, 27 aa, artificial
  clinical isolate peptide
GGPPDTPRVNMGGGKWWMLVPRTFGTT